(19) United States
(12) Patent Application Publication
(10) Pub. No.: US 2006/0236269 A1
(43) Pub. Date: Oct. 19, 2006

(54) Method and an apparatus for displaying calendar information to a user

(76) Inventor: Amir Borna, San Francisco, CA (US)

Correspondence Address: ORACLE INTERNATIONAL CORPORATION;c/o PARK, VAUGHAN & FLEMING LLP, 2820 FIFTH STREET, DAVIS, CA, 95618-7759, US

(21) Appl. No.: 11/109,591

(22) Filed: Apr. 18, 2005

(51) Int. Cl. G06F 17/00

(52) U.S. Cl. 715/963

(57) ABSTRACT

One embodiment of the present invention provides a system that facilitates displaying calendar information on a display. The system operates by displaying a status bar in a location on the display, which does not preclude other content from being displayed simultaneously. In addition, the system displays a calendar timeline including calendar information in the status bar, wherein one end of the calendar timeline represents a beginning of a displayed time period and an opposite end of the calendar timeline represents an end of the displayed time period. Moreover, the status bar is continuously viewable to a user regardless of what other content is being displayed on the display.

### BACKGROUND

1. Field of the Invention

The present invention relates to user interfaces for computer systems. More specifically, the present invention relates to a method and an apparatus for displaying calendar information to a user.

2. Related Art

Recent advances in Personal Digital Assistants (PDAs), smart phones, and associated Personal Information Management (PIM) software have resulted in significant increases in user productivity, which has lead to widespread adoption of PIM software and associated devices.

Even though there have been major advances in the design of PIM software, the current generation of PIM software is not without limitations. For example, when a user is busy working on a project on a computer and receives a phone call from another person asking if he or she is free for an appointment at a specific time, the user typically has to navigate away from their current work and open their PIM application. In addition, the user then has to navigate to the calendar portion of the PIM application and possibly has to navigate to the desired time slot. At this point, the user is able to see if he or she is available at the requested time.

Once a scheduling request or inquiry has been completed, the user then navigates back to the application that he or she was working on. The time it takes to navigate back and forth between applications is both time consuming, and a burden to productivity.

Hence, what is needed is a method and an apparatus for interfacing with calendar information without the problems listed above.

### SUMMARY

One embodiment of the present invention provides a system that facilitates displaying calendar information on a display. The system operates by displaying a status bar in a location on the display, which does not preclude other content from being displayed simultaneously. In addition, the system displays a calendar timeline including calendar information in the status bar, wherein one end of the calendar timeline represents a beginning of a displayed time period and an opposite end of the calendar timeline represents an end of the displayed time period. Moreover, the status bar is continuously viewable to a user regardless of what other content is being displayed on the display.

In a variation of this embodiment, displaying the calendar timeline on the status bar involves displaying an indicator on the calendar timeline, which indicates a current time.

In a further variation, the system displays appointment information for the user on the calendar timeline, wherein an appointment is displayed as an appointment box on the calendar timeline. One edge of the appointment box is placed on the calendar timeline at a position corresponding with a starting time of the appointment and an opposite end of the appointment box is placed on the calendar timeline at a position corresponding with an ending time of the appointment. Moreover, the appointment box has different visual properties than the calendar timeline to facilitate differentiation by the user of time that is scheduled in appointments from time that is not scheduled in appointments.

In a further variation, the system receives a click from the user on the appointment box. In response to the click, the system opens the appointment properties in a new window to facilitate modification of the appointment properties by the user.

In a further variation, the system receives a dragging command from the user on an edge of the appointment box. In response to the dragging command, the system modifies a corresponding boundary time of the appointment to correspond to the new position of the edge of the appointment box. Note that the boundary time represents either the starting time or the ending time of the appointment.

In a further variation, the system receives a dragging command from the user on the appointment box. In response to the dragging command, the system modifies the corresponding boundary times of the appointment to correspond to the new positions of the edges of the appointment box. Note that the boundary time represents either the starting time or the ending time of the appointment.

In a further variation, the system receives a click from the user on an empty portion of the calendar timeline. In response to the click, the system opens a new appointment properties window to facilitate creation of a new appointment by the user.

In a further variation, the system receives a click from the user on a navigation button on the calendar timeline. In response to the click, the system moves the calendar timeline a pre-determined distance forward, moves the calendar timeline a pre-determined distance backward, moves the calendar timeline to a next scheduled appointment, moves the calendar timeline to a last scheduled appointment, opens a new window that allows the user to move the calendar timeline to a specific date and time, or adjusts a scale of the calendar timeline.

In a further variation, the system displays a total of all time scheduled in appointments (the sum of the length of all of the currently scheduled meetings for the displayed time period) or a total of all time not scheduled in appointments (the sum of the amount of time that is available for scheduling for the displayed time period).

In a variation of this embodiment, the system displays the current date and time on the status bar.

In a variation of this embodiment, the system displays an instant messaging status on the status bar. The instant messaging status provides an availability status of the user to a third-party. Note that the instant messaging status can be set manually or automatically based on schedule information.

In a variation of this embodiment, the system displays status information of a currently executing process on the status bar.

In a variation of this embodiment, the system displays the content of modal dialogs on the status bar.

### BRIEF DESCRIPTION OF THE FIGURES

FIG. 1 illustrates a computer in accordance with an embodiment of the present invention.

FIG. 2 illustrates a user interface in accordance with an embodiment of the present invention.

FIG. 3 illustrates a date-selection tool in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Computer System

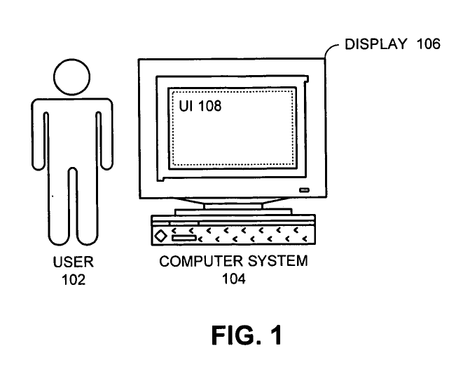

FIG. 1 illustrates a computer system 104 in accordance with an embodiment of the present invention. Computer system 104 can generally include any type of computer system, including, but not limited to, a computer system based on a microprocessor, a mainframe computer, a digital signal processor, a portable computing device, a personal organizer, a device controller, and a computational engine within an appliance.

Computer system 104 includes display 106. Display 106 outputs a visual representation of user interface 108 to user 102, thereby facilitating interaction between user 102 and computer system 104.

User Interface

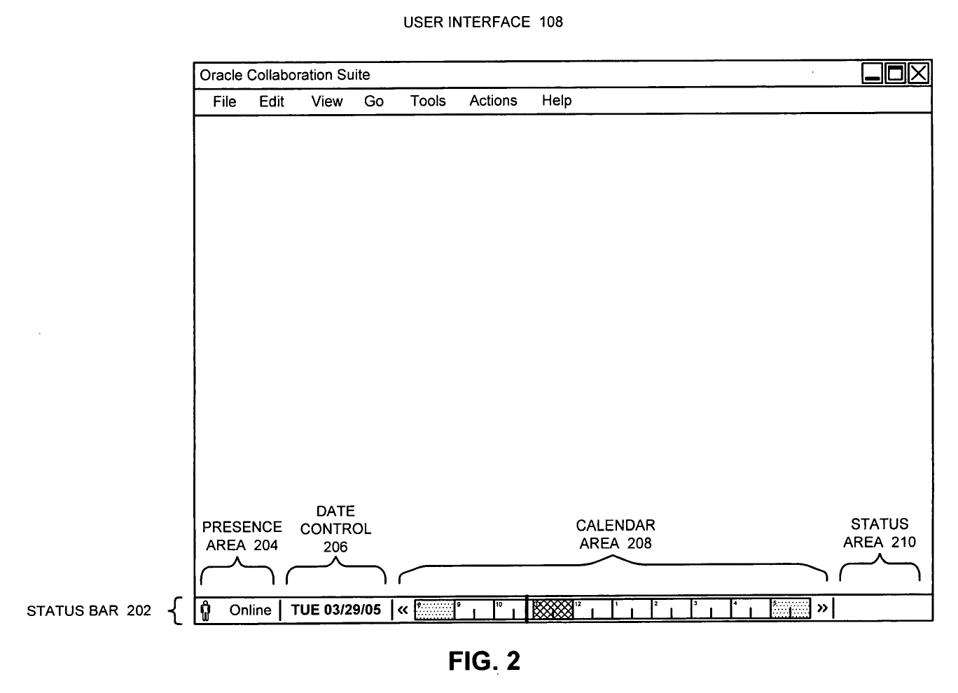

FIG. 2 illustrates a user interface 108 in accordance with an embodiment of the present invention. User interface 108 includes status bar 202. In one embodiment of the present invention, status bar 202 is always visible to user 102, regardless of what other information is being presented to user 102 within user interface 108.

Status bar 202 includes presence area 204, date control 206, calendar area 208, and status area 210. Note that status bar 202 is not drawn to scale, and the size and the arrangement of components within status bar 202 may vary with different embodiments of the present invention. Also note that the location of status bar 202 may be changed by user 102.

In one embodiment of the present invention, the relative proportions of status bar 202 occupied by presence area 204, date control 206 with calendar area 208, and status area 210 remain fixed as user 102 changes the overall size of status bar 202.

Presence Area

Presence area 204 displays the instant messaging status, in text as well as via an icon, to user 102. The text displays the availability message that is shown to other users that check the availability of user 102. Clicking on the text in presence area 204 invokes a menu that allows user 102 to change the text or set various other options relating to instant messaging. User 102 may also choose random text to display for his or her availability, as well as automatic text that is dependant on the scheduling information in calendar area 208.

The icon in presence area 204 displays how other users see the status of user 102 as defined by the instant messaging application. Additionally, the icon provides feedback to user 102, such as if user 102 is offline or if the instant messaging server is unavailable.

Calendar Area

Calendar area 208 provides a quick snapshot of scheduled appointments for a selected day to user 102. As illustrated in FIG. 2, calendar area 208 displays the information for Tuesday, Mar. 29, 2005 as indicated in date control 206. In the embodiment of the present invention illustrated in FIG. 2, user 102 is unavailable prior to 9:00 am, and after 5:00 pm, as user 102's working hours are defined as 9:00 am t 5:00 pm. In addition, user 102 has an appointment scheduled from 11:00 am to noon. The current time is represented by a vertical bar through calendar area 208. In FIG. 2, the current time is approximately 10:50 am. Note that the starting time and the ending time displayed in calendar area 208 can be configured by user 102, as well as various visual attributes, such as color, texture, and special effects, for displaying free time, scheduled time, and non-working hours. In one embodiment of the present invention, user 102 sets his or her working hours, and the system sets the starting time one-hour prior to that start of working hours and sets the ending time one hour after the end of working hours.

By hovering a pointer over various controls and objects in status bar 202, user 102 can receive feedback as to what actions can be taken, as well as receiving more information about the object that is under the pointer. For example, by hovering the mouse over the appointment scheduled for 11:00 am in calendar area 208, user 102 can receive more information about the scheduled appointment, such as the title, attendees, location, etc.

In one embodiment of the present invention, various controls allow user 102 to navigate among the appointments scheduled. User 102 can click on hour forward, hour backward, day forward, and day backward which advances the timeline in calendar area 208 by one hour forward, one hour backward, one day forward, and one day backward, respectively. In addition, double-clicking on one hour forward or one hour backward will move the timeline to the next meeting in the currently selected day or the previous meeting in the currently selected day. Likewise, double-clicking on day forward or day backward will advance the timeline to the next day with a scheduled appointment or the last day with a scheduled appointment.

User 102 may additionally click any unscheduled area of the timeline to open an appointment scheduling dialog.

In one embodiment of the present invention, appointments with reminders can be displayed with various visual effects, as well as accompanied with an audio alert. For example, at a scheduled reminder time, computer system 104 can sound a chime, and the appointment for which the reminder has activated can be represented by a flashing box or various other animations.

Date Control

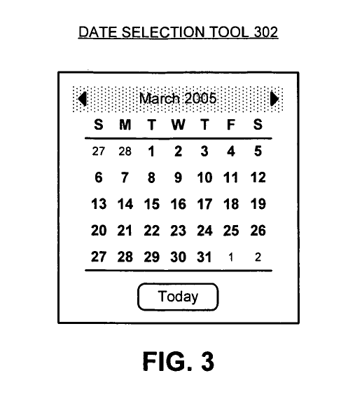

Date control 206 displays the date for the time period displayed in calendar area 208. In one embodiment of the present invention, the date is displayed in a short-date format. Hovering over the date will display the date in long-date format, such as “Tuesday, Mar. 29, 2005”. Clicking on date control 206 will display the date-selection tool 302 as illustrated in FIG. 3.

Clicking on a day in date-selection tool 302 sets the date for the time displayed in calendar area 208 to the day that user 102 clicked. User 102 can use date-selection tool 302 to navigate to any arbitrary date. Controls are provided to advance date-selection tool 302 forward or backward one month at a time. In addition, user 102 can click on the month and year to change to any desired month and year.

User 102 is also presented with a “today” button that, upon clicking, sets the date for calendar area 208 to the current date.

Status Area

Status area 210 can be used for displaying notifications as well as for displaying information about currently running processes. In addition, status area 210 can contain a stop or cancel button to terminate currently running tasks or processes.

In one embodiment of the present invention, status area 210 can be used to display the contents of modeless dialogs, such as impending appointment notifications.

Status notifications can be accompanied by various audio and visual effects, such as a chime and flashing text.

Note that one embodiment of the present invention includes date control 206 and calendar area 208, and does not include presence area 204 or status area 210.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for displaying calendar information on a display, comprising:
displaying a status bar in a location on the display which does not preclude other content from being displayed simultaneously on the display;
displaying a calendar timeline including calendar information in the status bar, wherein one end of the calendar timeline represents a beginning of a displayed time period and an opposite end of the calendar timeline represents an end of the displayed time period; and
wherein the status bar is continuously viewable to a user regardless of what other content is being displayed on the display.

2. The method of claim 1, wherein displaying the calendar timeline on the status bar involves displaying an indicator on the calendar timeline, which indicates a current time.

3. The method of claim 2, further comprising:
displaying appointment information for the user on the calendar timeline, wherein an appointment is displayed as an appointment box on the calendar timeline, and wherein one edge of the appointment box is placed on the calendar timeline at a position corresponding with a starting time of the appointment, and an opposite end of the appointment box is placed on the calendar timeline at a position corresponding with an ending time of the appointment; and
wherein the appointment box has different visual properties than the calendar timeline to facilitate differentiation by the user of time that is scheduled in appointments from time that is not scheduled in appointments.

4. The method of claim 2, further comprising:
receiving a click from the user on the appointment box; and
in response to the click, opening the appointment properties in a new window to facilitate modification of the appointment properties by the user.

5. The method of claim 2, further comprising:
receiving a dragging command from the user on an edge of the appointment box; and
in response to the dragging command, modifying a corresponding boundary time of the appointment to correspond to the new position of the edge of the appointment box, wherein the boundary time represents one of the starting time or the ending time for the appointment.

6. The method of claim 2, further comprising:
receiving a dragging command from the user on the appointment box; and
in response to the dragging command, modifying the corresponding boundary times of the appointment to correspond to the new positions of the edges of the appointment box, wherein the boundary times represent the starting time and the ending time for the appointment.

7. The method of claim 2, further comprising:
receiving a click from the user on an empty portion of the calendar timeline; and
in response to the click, opening a new appointment properties window to facilitate creation of a new appointment by the user.

8. The method of claim 2, further comprising:
receiving a click from the user on a navigation button on the calendar timeline; and
in response to the click, performing one of the following operations:
moving the calendar timeline a pre-determined distance forward,
moving the calendar timeline a pre-determined distance backward,
moving the calendar timeline to a next scheduled appointment,
moving the calendar timeline to a last scheduled appointment,
opening a new window that allows the user to move the calendar timeline to a specific date and time, and
adjusting a scale of the calendar timeline.

9. The method of claim 2, further comprising displaying one of a total of all time scheduled in appointments or a total of all time not scheduled in appointments.

10. The method of claim 1, further comprising displaying a current date and time on the status bar.

11. The method of claim 1, further comprising displaying an instant messaging status on the status bar, wherein the instant messaging status provides an availability status of the user to a third-party, and wherein the instant messaging status can be set manually or automatically based on schedule information.

12. The method of claim 1, further comprising displaying status information of a currently executing process on the status bar.

13. The method of claim 1, further comprising displaying the content of modeless dialogs on the status bar.

14. An apparatus for displaying calendar information on a display, comprising:
a display mechanism configured to display a status bar in a location on the display which does not preclude other content from being displayed simultaneously on the display;
wherein the display mechanism is further configured to display a calendar timeline including calendar information in the status bar, wherein one end of the calendar timeline represents a beginning of a displayed time period and an opposite end of the calendar timeline represents an end of the displayed time period; and
wherein the status bar is continuously viewable to a user regardless of what other content is being displayed on the display.

15. A computer-readable storage medium storing instructions that when executed by a computer cause the computer to perform a method for displaying calendar information on a display, the method comprising:
displaying a status bar in a location on the display which does not preclude other content from being displayed simultaneously on the display;
displaying a calendar timeline including calendar information in the status bar, wherein one end of the calendar timeline represents a beginning of a displayed time period and an opposite end of the calendar timeline represents an end of the displayed time period; and
wherein the status bar is continuously viewable to a user regardless of what other content is being displayed on the display.

16. The computer-readable storage medium of claim 15, wherein displaying the calendar timeline on the status bar involves displaying an indicator on the calendar timeline, which indicates a current time.

17. The computer-readable storage medium of claim 16, wherein the method further comprises:
displaying appointment information for the user on the calendar timeline, wherein an appointment is displayed as an appointment box on the calendar timeline, and wherein one edge of the appointment box is placed on the calendar timeline at a position corresponding with a starting time of the appointment, and an opposite end of the appointment box is placed on the calendar timeline at a position corresponding with an ending time of the appointment; and
wherein the appointment box has different visual properties than the calendar timeline to facilitate differentiation by the user of time that is scheduled in appointments from time that is not scheduled in appointments.

18. The computer-readable storage medium of claim 16, wherein the method further comprises:
receiving a click from the user on the appointment box; and
in response to the click, opening the appointment properties in a new window to facilitate modification of the appointment properties by the user.

19. The computer-readable storage medium of claim 16, wherein the method further comprises:
receiving a dragging command from the user on an edge of the appointment box; and
in response to the dragging command, modifying a corresponding boundary time of the appointment to correspond to the new position of the edge of the appointment box, wherein the boundary time represents one of the starting time or the ending time for the appointment.

20. The computer-readable storage medium of claim 16, wherein the method further comprises:
receiving a dragging command from the user on the appointment box; and
in response to the dragging command, modifying the corresponding boundary times of the appointment to correspond to the new positions of the edges of the appointment box, wherein the boundary times represent the starting time and the ending time for the appointment.
